(19) United States
(12) Patent Application Publication
(10) Pub. No.: US 2004/0245925 A1
(43) Pub. Date: Dec. 9, 2004

(54) Electron tube and method of manufacturing the electron tube

(76) Inventors: Kuniyoshi Yamauchi, Hamamatsu-shi (JP); Hiroshi Kondoh, Hamamatsu-shi (JP)

Correspondence Address: MORGAN LEWIS & BOCKIUS LLP, 1111 PENNSYLVANIA AVENUE NW, WASHINGTON, DC, 20004, US

(21) Appl. No.: 10/482,767

(22) PCT Filed: Jul. 5, 2002
(86) PCT No.: PCT/JP02/06865

(30) Foreign Application Priority Data
Jul. 5, 2001 (JP) 2001-205235

(51) Int. Cl. H01J 43/00; H01J 43/04

(52) U.S. Cl. 313/532; 313/528; 313/536; 313/103 R

(57) ABSTRACT

An electron tube 10 is provided with: an MCP (electron multiplier) 14 which includes a multiplying portion 16 having a large number of microscopic holes for electron passage that can emit secondary electrons and a peripheral portion 18 that surrounds multiplying portion 16; and with a vacuum closed container 12 enclosing at least multiplying portion 16 of MCP 14. Thus, peripheral portion 18 of MCP 14 forms at least a portion of sidewalls 22 of vacuum closed container 12. Multiplying portion 16 is increased in size in this configuration in comparison with configurations having the same outer dimensions that accommodate the entirety of an MCP inside of vacuum closed container 12.

### TECHNICAL FIELD

This invention relates to an electron tube incorporating an electron multiplier such as a micro-channel plate (hereinafter referred to as “MCP”) and to a manufacturing method for the same.

### BACKGROUND ART

Some types of photomultiplier tubes incorporate an MCP as an electron multiplier for multiplying secondary electrons. As schematically shown in FIG. 13, a photoelectric surface (photocathode) 3 is formed on an inner surface of an input end 2 of a vacuum closed container 1 in a conventional MCP built-in type photomultiplier tube and an MCP 4 is placed parallel to photoelectric surface 3 inside of container 1. MCP 4 is basically formed of a glass plate wherein a large number of extremely microscopic tubes (channel multipliers) having resistors and secondary electron emitters as their inner wall surfaces are bundled. In addition, the peripheral portion of MCP 4, which is referred to as edge glass 5, has no microscopic tubes so as to be made easier to handle. Supports 6 are secured to appropriate places of the respective surfaces of edge glass 5, wherein the end portions of these supports 6 are embedded in sidewalls 7 of vacuum closed container 1, so that MCP 4 is supported in the condition where MCP 4 is completely accommodated within vacuum closed container 1.

Other MCP built-in type electron tubes such as an image intensifier, and the like, described in the official gazette of Japanese Patent Application Laid-Open No. H06-176717 and the official gazette of Japanese Patent Application Laid-Open No. H06-295690 have similar configurations as described above.

### DISCLOSURE OF THE INVENTION

The inventor has discovered the following problems as a result of examination of the above described prior art. That is to say, the entirety of MCP 4 is placed inside of sidewalls 7 of vacuum closed container 1 in the electron tube of the conventional photomultiplier tube described above and, therefore, the area of multiplying portion 8 of MCP 4, that is to say, the area of portion 8 made of a group of microscopic tubes inside of edge glass 5, is smaller than the inner area of input end 2 of closed container 1. Accordingly, an effectively functioning portion 3a of photoelectric surface 3 formed on the entire surface of the inner area of input end 2 is also small in comparison with the outer dimensions of the electron tube. This becomes one factor that prevents miniaturization of a device that uses an electron tube.

In addition, a portion that doesn't function as photoelectric surface 3 (dead space) becomes significantly large in a device wherein the utilized electron tubes are arranged in a matrix form under the condition wherein the electron tubes make contact with each other and, therefore, a problem arises wherein functions and performance of the device are decreased. Though this problem can be solved to a certain extent by modifying the shape of the cross section of the electron tubes from a generally used circular form to a square, rectangular or hexagonal form, there is a limit in the scaling down of the dead space because effective portion 3a of photoelectric surface 3 of each of the electron tubes is small.

The present invention is provided in order to solve the above described problems and an object of the invention is to provide an electron tube having a large multiplying portion of the electron multiplier in comparison with a conventional electron tube having the same outer dimensions as well as a manufacturing method for the same.

An electron tube according to the present invention is provided with: an electron multiplier which has a multiplying portion including a large number of microscopic holes for electron passage that allow for emission of secondary electrons and a peripheral portion that surrounds the multiplying portion; and with a vacuum closed container enclosing at least the multiplying portion of the electron multiplier. Thus the electron tube is characterized in that the peripheral portion of the electron multiplier forms at least a portion of the sidewalls of the vacuum closed container.

The peripheral portion of the electron multiplier forms at least a portion of the sidewalls of the vacuum closed container in this configuration and, therefore, the area of the multiplying portion of the electron multiplier increases in comparison with the conventional configuration having the same outer dimensions wherein the entirety of the electron multiplier is accommodated inside of the vacuum closed container.

The electron tube according to the present invention maybe a photomultiplier tube wherein a photoelectric surface is formed inside of the vacuum closed container so as to be opposed to one surface of the multiplying portion of the electron multiplier and wherein an anode is formed inside of the vacuum closed container so as to be opposed to the other surface of the multiplying portion of the electron multiplier.

In addition, the electron tube according to the present invention may be an image intensifier wherein a photoelectric surface is formed inside of the vacuum closed container so as to be opposed to one surface of the multiplying portion of the electron multiplier and wherein a fluorescent screen is formed inside of the vacuum closed container so as to be opposed to the other surface of the multiplying portion of the electron multiplier.

The multiplying portion of the electron multiplier is increased in size within the vacuum closed container so that the area of the effective portion of the photoelectric surface formed inside of the above described photomultiplier tube, or image intensifier, is increased.

The electron tube according to the present invention may be characterized in that the vacuum closed container has a pair of plates placed parallel to each other and sandwiching the electron multiplier wherein the peripheral portion of the electron multiplier is joined to a peripheral portion of each of the plates.

At this time, the electron tube may be characterized in that the peripheral portion of at least one of the pair of plates includes a protrusion so that the peripheral portion of the electron multiplier is joined to the protrusion.

The electron tube according to the present invention may be characterized in that the electron multiplier includes a micro-channel plate. The micro-channel plate is appropriately used in the photomultiplier.

The electron tube according to the present invention may be characterized in that the outer peripheral surface of the peripheral portion of the electron multiplier is exposed to the outer side. In such a manner, the outer peripheral surface of the peripheral portion of the electron multiplier is exposed to the outer side so as to form at least a portion of the sidewall of the vacuum closed container.

The electron tube according to the present invention may be characterized in that the multiplying portion and the peripheral portion of the electron multiplier may be integrated. In such a manner, the electron multiplier is provided as an integrated body so as to be made easy to be handled.

The thickness of the peripheral portion of the electron multiplier may be greater than the thickness of the multiplying portion or may be substantially the same as the thickness of the multiplying portion in the electron tube according to the present invention.

A manufacturing method for an electron tube according to the present invention is characterized in that a pair of plates as well as an electron multiplier which has a multiplying portion including a large number of microscopic holes for electron passage that allow for emission of secondary electrons and a peripheral portion that surrounds the multiplying portion are prepared and in that the electron multiplier is sandwiched between the pair of plates and at the same time the peripheral portion of the electron multiplier is joined to a peripheral portion of each of the pair of plates.

According to this method, the electron multiplier is sandwiched between the pair of plates while the peripheral portion of the electron multiplier is joined to a peripheral portion of each of the pair of plates and, thereby, an electron tube wherein the peripheral portion of the electron multiplier forms at least a portion of the sidewall of the vacuum closed container can be efficiently manufactured.

It becomes possible to understand the present invention more sufficiently from the following detailed description and the attached drawings. These are shown simply for illustration and should not be considered to limit the present invention.

### BRIEF DESCRIPTION OF THE DRAWINGS

FIG. 1 is a longitudinal sectional view of a photomultiplier tube according to the first embodiment;

FIG. 2 is a plan view of the photomultiplier tube of FIG. 1;

FIG. 3A and FIG. 3B are schematic diagrams showing a manufacturing method for an MCP;

FIG. 4A and FIG. 4B are schematic diagrams showing another manufacturing method for an MCP;

FIG. 5A and FIG. 5B are diagrams showing a manufacturing method for a glass plate;

FIG. 6 is a diagram showing a manufacturing method for the photomultiplier tube shown in FIG. 1;

FIG. 7 is a plan view showing the condition wherein the same photomultiplier tubes of FIG. 1 are arranged in a matrix form;

FIG. 8 is a longitudinal sectional view showing a photomultiplier tube according to the second embodiment;

FIG. 9 is a longitudinal sectional view showing an image intensifier according to the third embodiment;

FIG. 10 is a plan view of the image intensifier of FIG. 9;

FIG. 11 is a perspective view showing an MCP having another configuration as an electron multiplier, wherein a portion is cut out;

FIG. 12A is a perspective view showing an MSP as an electron multiplier, wherein a portion is cut out;

FIG. 12B is an enlarged view showing portion A of FIG. 12A; and

FIG. 13 is a longitudinal sectional view showing a conventional photomultiplier tube.

### BEST MODE FOR CARRYING OUT THE INVENTION

In the following, the preferred embodiments of the present invention are described in detail in reference to the attached drawings. Here, the same symbols are attached to the same elements in the description of the drawings so that repetitive descriptions are omitted.

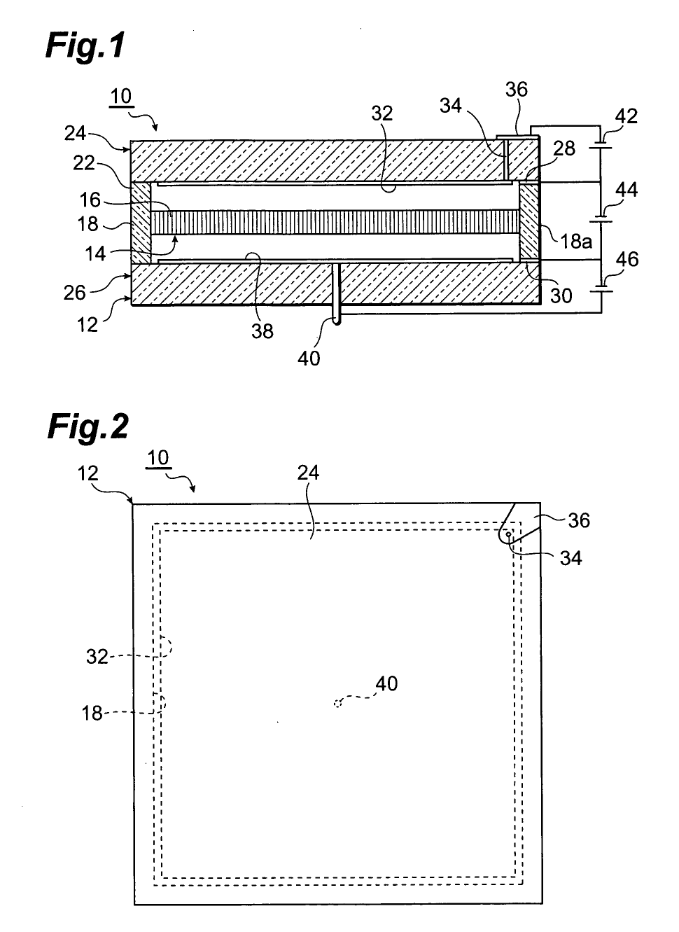

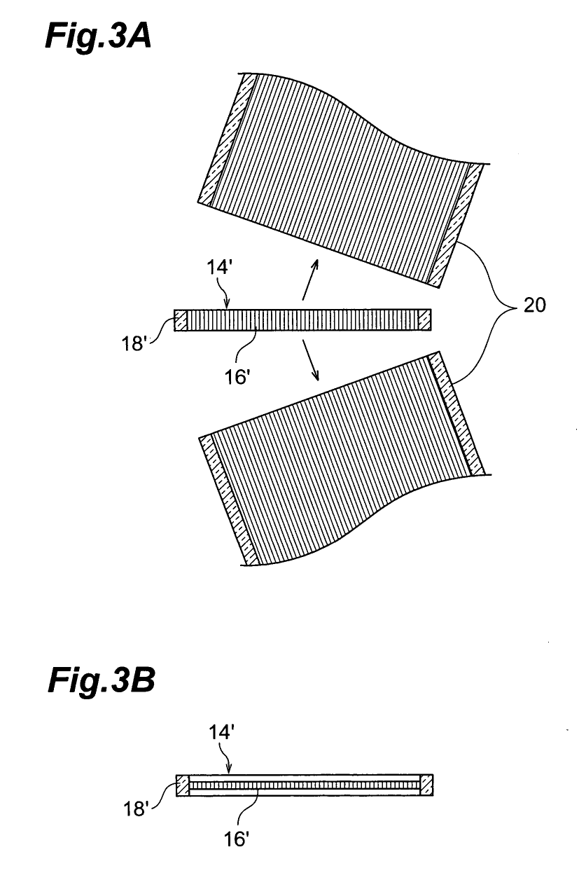

FIG. 1 and FIG. 2 show a photomultiplier tube according to the first embodiment. As shown in FIG. 2, this photomultiplier tube 10 is provided with a vacuum closed container 12 having an approximately square form in lateral cross section and with an MCP (electron multiplier) 14 for multiplying secondary electrons in an approximately square plane form.

MCP 14 is formed of: an approximately square portion (hereinafter referred to as “MCP multiplying portion”) 16 having a large number of extremely microscopic tubes (channel multipliers) as holes for electron passage of which the inner wall surfaces are used as resistors and secondary electron emitters; and edge glass (peripheral portion) 18 that surrounds the periphery of the approximately square portion. The above described MCP multiplying portion 16 and edge glass 18 are integrated. The thickness of edge glass 18 is considerably great in comparison with MCP amplifying portion 16 so as to have rigidity to a certain extent so that MCP 14 can be easily handled.

MCP multiplying portion 16 of MCP 14 is placed inside of vacuum closed container 12. Thus, edge glass 18 of MCP 14 forms portions of sidewalls 22 of vacuum closed container 12. That is to say, two glass plates 24 and 26 in an approximately square form, that is the same form as the outer form of MCP 14, having the same dimensions sandwich edge glass 18 in the condition wherein outer peripheral surface 18a is exposed to the outer side and are joined to the end surfaces of edge glass 18 in an air tight manner. As a result, one vacuum closed container 12 is formed of these glass plates 24 and 26 as well as edge glass 18 of MCP 14.

One glass plate 24 serves as an input end of vacuum closed container 12 into which light enters and a photoelectric surface (photocathode) 32 is formed over approximately the entire area of the surface of the input end on the MCP 14 side. This photoelectric surface 32 is placed parallel to MCP multiplying portion 16 in a coaxial manner. As can be understood from FIG. 1, the area of photoelectric surface 32 is of approximately the same size as the entire area of the outer surface of glass plate 24 except for the portion that is joined to edge glass 18 of MCP 14 and this substantially agrees with the area of MCP multiplying portion 16. Accordingly, the entire surface of photoelectric surface 32 formed on the inner area of input end 24 of vacuum closed container 12 functions as an effective portion. One end of a conductive pin 34 that penetrates glass plate 24 in a corner in an airtight manner is electrically connected to a corner of photoelectric surface 32 while the other end of pin 34 is electrically connected to a photoelectric surface electrode 36 formed in a corner of the outer surface of glass plate 24.

The other glass plate 26 is an output end of vacuum closed container 12 and the surface on the MCP 14 side has an electrode 38 formed over approximately the entire area thereof. This electrode 38 serves as an anode so as to capture secondary electrons that have been emitted from MCP 14. Electrode (hereinafter referred to as “anode”) 38 is placed parallel to MCP multiplying portion 16 in a coaxial manner and has substantially the same area as the area of MCP multiplying portion 16 in the same manner as photoelectric surface 32. An output terminal 40 penetrates in the center of glass plate 26 in an airtight manner and this output terminal 40 is electrically connected to anode 38.

Thus, terminals 28 and 30 electrically connected to electrodes (not shown) on the two surfaces of MCP multiplying portion 16, are respectively placed between edge glass 18 and glass plates 24 and 26 so as to allow for the application of voltage to the respective electrodes from the outside of photomultiplier tube 10.

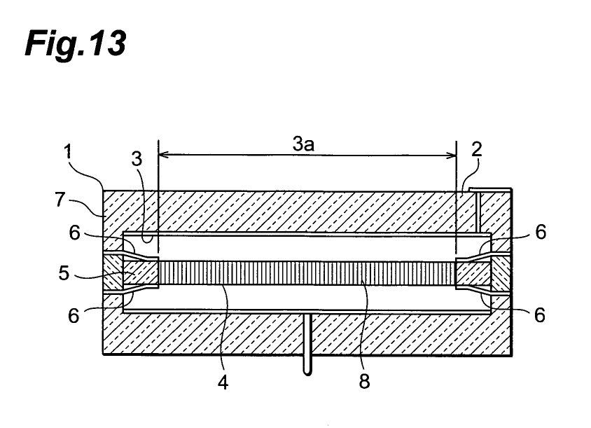

The form of MCP multiplying portion 16 substantially agrees with the form of the cross section in the lateral direction of the inner space of vacuum closed container 12 and, therefore, the area of MCP multiplying portion 16 is increased according to the present embodiment in comparison with the conventional configuration shown in FIG. 13 wherein the entirety of MCP 4 is placed in the inner space of vacuum closed container 1 in the case wherein vacuum closed container 1 has the same outer dimensions as vacuum closed container 12.

Next, a manufacturing method for photomultiplier tube 10 having the above described configuration is described.

First, MCP 14 is manufactured. It is preferable for MCP 14 to be manufactured as follows.

First, a glass rod having acid solubility is inserted into a glass tube having resistance to acid that includes, for example, PbO and an electron multiplying substance and the two are heated so as to be softened and simultaneously expanded so that they become fused. According to the operation, a fine wire having a double structure wherein acid soluble glass is covered with acid resistant glass is obtained. Next, a large number (for example, approximately 10³) of wires that are the same as this wire are bundled in parallel so as to be contained in a frame of hexagonal pillar form and then this is heated so as to become fused to each other wherein the gaps among the respective wires are eliminated. Simultaneously, this wire bundle is expanded to become finer. Furthermore, a large number (for example, 1000) of wire bundles that are the same as the above described integrated wire bundle that has been expanded to become finer are aligned in parallel so as to be contained into a tubular frame of which the lateral cross section is approximately square, that is to say, into an acid resistant glass member to become edge glass 18 and this is again heated so that the wire bundles have become fused to each other and the frame and wire bundles are fused to each other with the gaps being eliminated. Thus, a body in rod form is made of a large number (for example, 10⁶) of extremely fine wires in double structure which are aligned parallel to each other and are fused to each other in a frame.

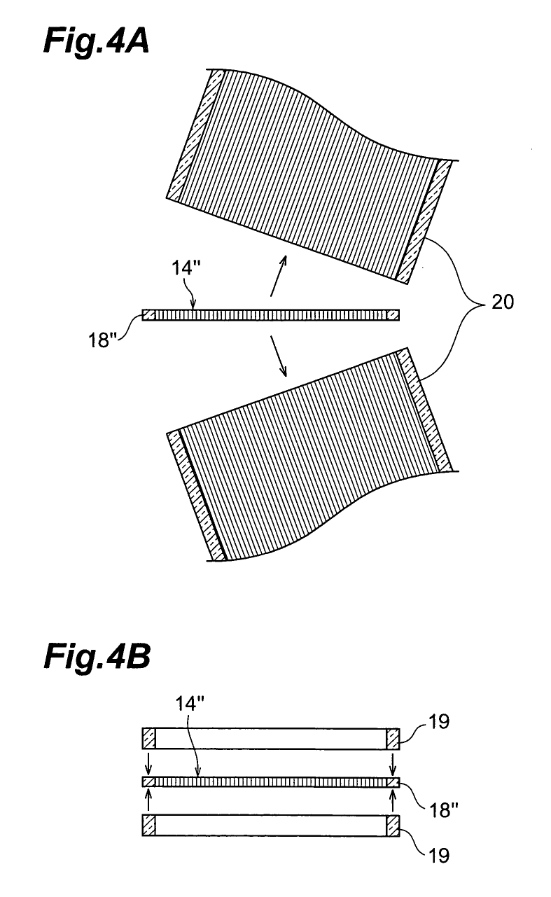

After this, as shown in FIG. 3A, body 20 in rod form is cut at right angles to, or at a predetermined appropriate angle vis-à-vis, the direction in which the wires extend into bodies 14′ in plate form having a predetermined thickness. The thickness of the plates at this time corresponds to the thickness of edge glass 18 in MCP 14 of a completed product. Furthermore, the cut surfaces inside of frame 18′ are polished so that the thickness of the plate is reduced to, for example, 1 mm or less (see FIG. 3B). Then this body 14′ in plate form is soaked in an appropriate acid solution for several hours. As a result, acid soluble glass which forms the core of each of the wires is removed so as to form body 14′ in plate form made of a portion 16′ wherein a large number of microscopic glass tubes are bundled and of a frame 18′ surrounding this glass tube bundle portion 16′.

Subsequently, this body 14′ in plate form is placed in a hydrogen gas atmosphere for several hours at, for example, approximately 400° C. and, thereby, PbO in the acid resistant glass that forms the glass tube bundle portions 16′ is reduced by H₂ so that Pb and H₂O are generated. A conductive layer is formed on the inner wall surface of each of microscopic glass tubes by means of Pb that has been generated in the above described manner so that each of the glass tubes functions as a channel multiplier. After this, an electrode (not shown) is formed on each of the surfaces of glass tube bundle portions 16′ inside of frame 18′ by means of a method such as the vacuum deposition so as to complete MCP 14. That is to say, glass tube bundle portion 16′ becomes MCP multiplying portion 16 and frame 18′ becomes edge glass 18.

Here, as shown in FIG. 4A and FIG. 4B, thin body 14″ in plate form is cut out from the above described body 20 in rod form and frame 18″ is also polished so that the thickness of frame 18″ is reduced to, for example, approximately 1 mm and after that glass 19 in annular form is fused to both sides of thin frame 18″ through heat and pressure applications and, thereby, MCP 14 can be manufactured.

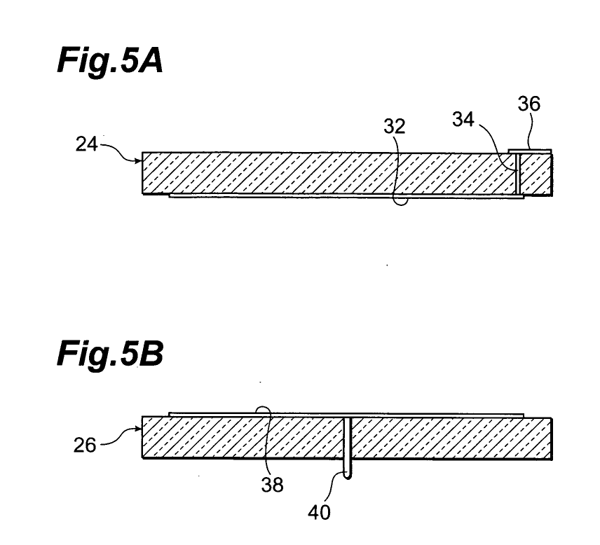

Next, glass plates 24 and 26 are manufactured. The size of one glass plate 24 is substantially the same size as the area of MCP 14. Then, as shown in FIG. 5A, a photoelectric surface (photocathode) 32 is formed over approximately the entire area of the lower surface of glass plate 24. The area of photoelectric surface 32 becomes approximately the same size as the entire area of the outer surface of glass plate 24 except for the portion that is joined to edge glass 18 of MCP 14, that is to say, it becomes substantially the same area as the area of MCP multiplying portion 16. One end of a conductive pin 34 that penetrates glass plate 24 in a corner in an airtight manner is electrically connected to a corner portion of photoelectric surface 32 while the other end of pin 34 is electrically connected to a photoelectric surface electrode 36 formed on the upper surface in the corner of glass plate 24.

The size of the other glass plate 26 is also substantially the same size as the area of MCP 14. Then, as shown in FIG. 5B, an electrode 38 is formed over approximately the entire area on the upper surface of glass plate 26. Electrode (anode) 38 has substantially the same area as MCP multiplying portion 16 in the same manner as photoelectric surface 32 of glass plate 24. An output terminal 40 is made to penetrate glass plate 26 in the center in an airtight manner and this output terminal 40 is electrically connected to anode 38.

Next, a terminal 28 is formed on the upper surface of edge glass 18 of MCP 14 in order to achieve an electrical connection to an electrode (not shown) on the upper surface of multiplying portion 16. On the other hand, a terminal 30 is formed on the lower surface of edge glass 18 of MCP 14 in order to achieve an electrical connection to an electrode (not shown) on the lower surface of multiplying portion 16.

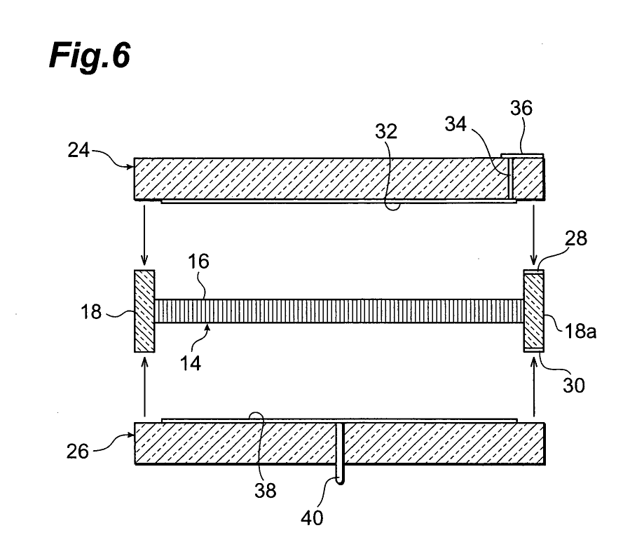

Then, as shown in FIG. 6, MCP 14 is sandwiched together from the top and the bottom by glass plates 24 and 26. Thus, the peripheral portion on the lower surface of glass plate 24 having no photoelectric surface 32 formed thereon is joined to the upper surface edge glass 18 of MCP 14. In addition, the peripheral portion of the upper surface of glass plate 26 having no anode 38 formed thereon is joined to the lower surface of edge glass 18 of MCP 14.

Here, edge glass 18 and glass plates 24 and 26 may be joined together according to any method as long as airtightness can be secured and a cold sealing method that utilizes an indium alloy or the like and a hot sealing method wherein the two are fused together through pressure application at a high temperature can be adopted.

A photomultiplier tube 10 as shown in FIG. 1 is formed by undergoing the above described process.

Next, the operation of photomultiplier tube 10 having such a configuration is described.

At the time when photomultiplier tube 10 is utilized, as shown in FIG. 1, direct current high-voltage power supplies 42, 44 and 46 are connected between photoelectric surface electrode 36 and electrode terminal 28, between electrode terminals 28 and 30 as well as between electrode terminal 30 and output terminal 40. Thus, predetermined voltages are applied between photoelectric surface 32 and the electrode on the input side of MCP multiplying portion 16, between the electrodes on both sides of MCP multiplying portion 16 as well as between the electrode on the output side of MCP multiplying portion 16 and anode 38, respectively.

In the case wherein light is made incident on glass plate 24 which is an input end under the above described condition, this light transmits glass plate 24 so as to hit photoelectric surface 32so that photoelectrons are emitted. These photoelectrons are led to MCP multiplying portion 16, pass through the respective channel multipliers so as to be multiplied and, then, are emitted from MCP multiplying portion 16. The electrons that have been emitted from MCP multiplying portion 16 are captured by anode 38 as an output signal.

As described above, photoelectric surface 32 and MCP multiplying portion 16 are opposed to each other and have approximately the same areas and, therefore, substantially all of the photoelectrons from photoelectric surface 32 are led to MCP multiplying portion 16. In addition, the area of photoelectric surface 32 is approximately the same as the area of the outer surface of glass plate 24 and, therefore, the area of the portion that effectively functions as photoelectric surface 32 has been expanded to a great degree in comparison with conventional photomultiplier tubes having the same outer dimensions as photomultiplier tube 10.

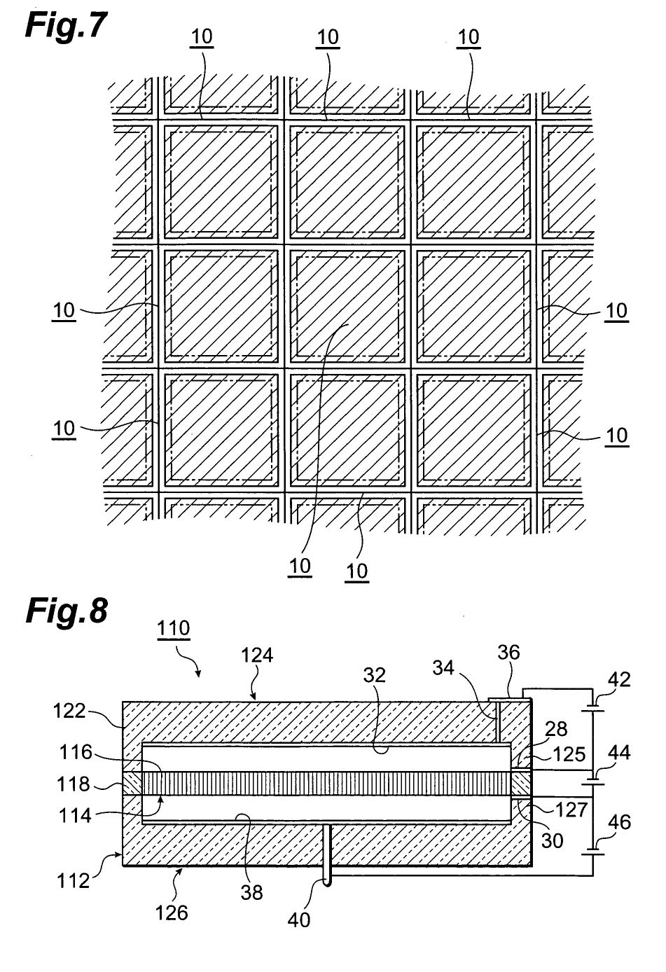

In the case where photomultiplier tube 10 is used when aligned in a matrix form as shown in FIG. 7, the effective photoelectric surface 32 becomes the hatched portion with an extremely small amount of dead space partially due to the form of their lateral cross section being approximately square. Accordingly, it becomes possible to efficiently convert incident light into an electrical signal. Here, the portion surrounded by the two-dotted chain line in FIG. 7 indicates the portion that effectively functions as a photoelectric surface in a conventional configuration and it can be seen from this drawing that the dead space has been reduced.

Next, an electron tube according to the second embodiment of the present invention is described. FIG. 8 shows a photomultiplier tube according to the second embodiment. This photomultiplier tube 110 is different from the photomultiplier tube according to the embodiment shown in FIG. 1 and FIG. 2 in the point wherein the thickness of edge glass 118 of MCP 114 is substantially equal to the thickness of MCP multiplying portion 116. In addition, protrusions 125 and 127 in annular form are integrally formed in peripheral portions of glass plates 124 and 126 that become input and output ends of vacuum closed container 112, respectively. The end surfaces of these protrusions 125 and 127 have substantially the same forms and same dimensions as edge glass 118 of MCP 114. The end surfaces of protrusions 125 and 127 are joined to edge glass 118 in an airtight manner by means of an appropriate joining means such as a cold sealing method or a hot sealing method. As a result, sidewalls 122 of vacuum closed container 112 are formed of protrusions 125 and 127 of glass plates 124 and 126 as well as of edge glass 118 of MCP 114 in the same manner as the first embodiment. Here, the configuration of the completed photomultiplier tube 110 is substantially the same as the photomultiplier tube shown in FIG. 1 and FIG. 2. Accordingly, the same symbols are attached to the same or corresponding elements from among the other elements in FIG. 8 and the descriptions of the working effects thereof are omitted.

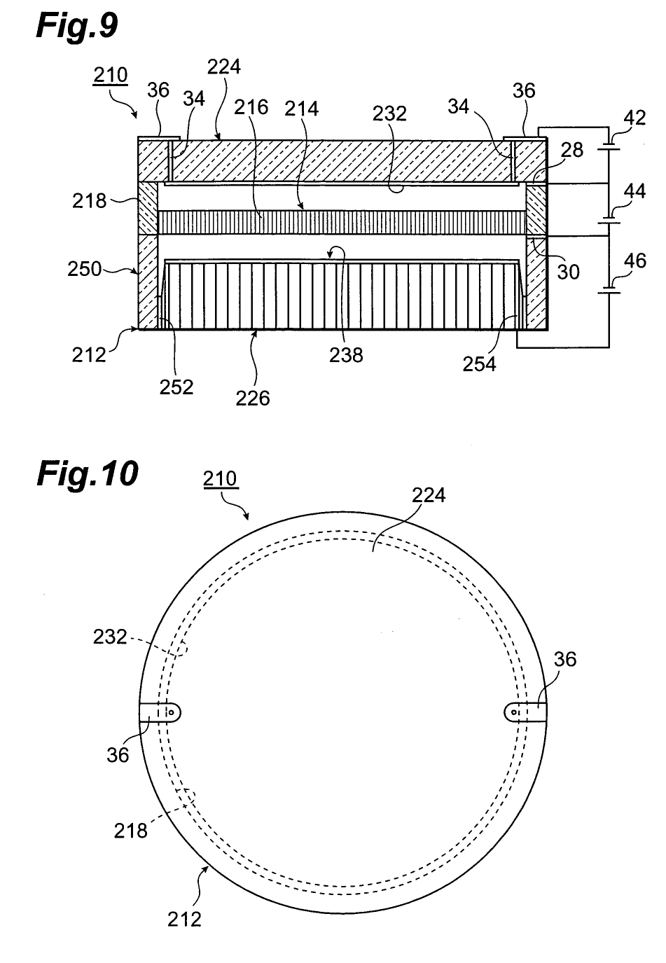

Next, an electron tube according to the third embodiment of the present invention is described. FIG. 9 and FIG. 10 show the electron tube according to the third embodiment. The electron tube according to the third embodiment is an image intensifier 210 to which the present invention has been applied.

Image intensifier 210 has the same configuration as photomultiplier tubes in the point of being provided with a vacuum closed container 212, a photoelectric surface 232 formed on the inner surface of an input end 224 of vacuum closed container 212 and an MCP 214 for the purpose of conversion of a faint optical image into electrons which are then amplified. Here, a fluorescent screen 238 in place of the anode is formed on the surface of an output end 226 on the MCP side in vacuum closed container 212 for the purpose of a second output as an enhanced optical image. In addition, output end 226 of vacuum closed container 212 is an optical fiber coupling plate formed of a large number of optical fibers which are bundled and coupled in image intensifier 210 shown in the drawing. Such a configuration itself is known in the art.

Image intensifier 210 according to the present embodiment has a cylindrical outer form. In addition, edge glass 218 of MCP 214 has a thickness greater than that of MCP multiplying portion 216. Edge glass 18 is in the form of protrusions from the respective surfaces of MCP multiplying portion 16 in MCP 14 shown in FIG. 1 and FIG. 2 while one end surface of edge glass 218 protrudes from one surface of MCP multiplying portion 216 and the other end surface is in the same plane as the other surface of MCP multiplying portion 216 according to the present embodiment. Thus, the flat circular glass plate 224 which becomes the input end is joined to the end surface on the protrusion side of edge glass 218 and a cylindrical glass 250 is joined to the other end surface. Optical fiber coupling plate 226 is attached to the inside of cylindrical glass 250 in an airtight manner by means of frit glass 252 or the like. As described above, edge glass 218 of MCP 214, glass plate 224, cylindrical glass 250 and optical fiber coupling plate 226 form vacuum closed container 212 of image intensifier 210.

Here, the conductive layer (not shown) that forms fluorescent screen 238 makes an electrical connection by means of electrode 254.

In the case where faint optical image is formed on the outer surface of glass plate 224 which is the input end under the condition wherein predetermined voltages are applied between photoelectric surface 232 and the electrode (not shown) of MCP multiplying portion 216 on the input side, between the electrodes (not shown) on both sides of MCP multiplying portion 216 as well as between the electrode (not shown) of MCP multiplying portion 216 on the output side and the conductive layer (anode) of fluorescent screen 238, respectively, in the above described configuration, that image is converted into photoelectrons on photoelectric surface 232 and after that the photoelectrons are led to MCP multiplying portion 216. Then, the electrons are multiplied in MCP multiplying portion 216 so as to be led to fluorescent screen 238. The electrons generate an enhanced optical image on fluorescent screen 238 so that the image is outputted through optical fiber coupling plate 226.

The area of MCP multiplying portion 216 and the area of photoelectric surface 232 are approximately equal while the area of photoelectric surface 232 is approximately the same as the area of the outer surface of glass plate 224 in the present embodiment and, therefore, the effective portion of photoelectric surface 232 is increased relative to the outer dimensions of image intensifier 210. Accordingly, miniaturization of a device that utilizes image intensifier 210, for example, of a night vision camera can be achieved.

Though the three preferred embodiments of the present invention are described in detail, a variety of modifications are possible without limiting the present invention to the above described embodiments.

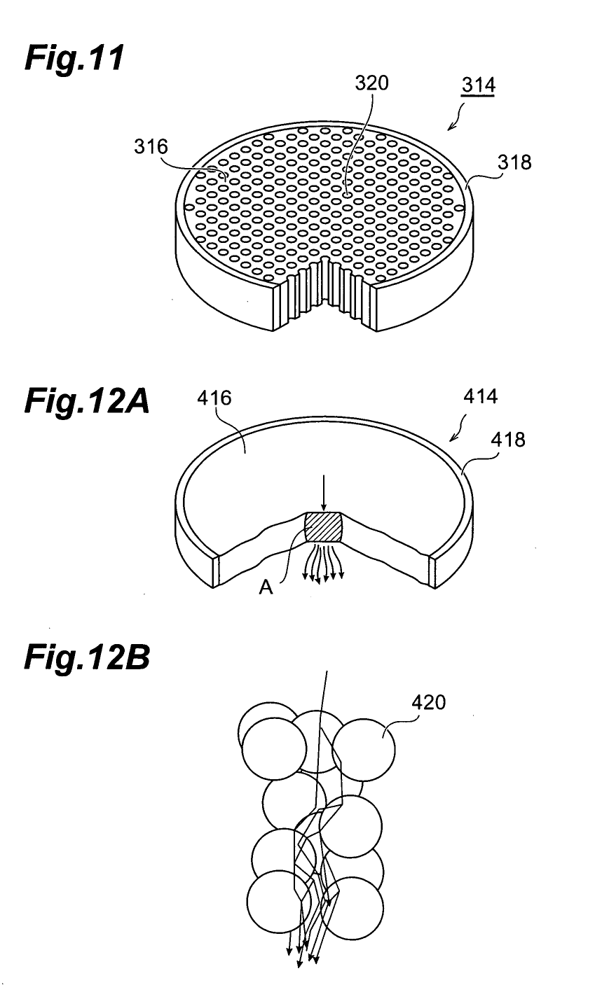

An MCP having a multiplying portion formed of a large number of bundled microscopic tubes that can emit secondary electrons within the inner wall surface and a peripheral portion that surrounds this multiplying portion is, for example, described as MCP 14, 114 or 214 which is an electron multiplier according to the above described embodiments. However, the configuration of the MCP is not limited to this but rather a configuration as disclosed in U.S. Pat. No. 5,997,713, for example, may be used. Such MCP 314 has, as shown in FIG. 11, a multiplying portion 316 with a large number of microscopic holes 320 for electron passage that can emit secondary electrons and a peripheral portion 318 that surrounds this multiplying portion 316. This MCP 314 is formed by etching predetermined portions of a p-doped silicone substrate so as to create a plurality of holes penetrating the substrate from the top surface to the bottom surface.

In addition, MCPs 14, 114 and 214 are described as electron multipliers in the above described embodiments. However, the electron multiplier is not limited to an MCP, but rather may be a so called microsphere plate (MSP) as disclosed in, for example, U.S. Pat. No. 5,939,613. Such MSP 414 has, as shown in FIG. 12A, a multiplying portion 416 with a large number of microscopic holes for electron passage that can emit secondary electrons and a peripheral portion 418 that is formed of glass or the like and that surrounds this multiplying portion 416. Multiplying portion 416 is, as shown in FIG. 12B, obtained by gathering a plurality of grain-like bodies 420 that can emit secondary electrons in an amorphous arrangement. As a result, the gaps among the plurality of grain-like bodies 420 form microscopic holes for electron passage that can emit secondary electrons.

In addition, the form of the lateral cross section of the electron tube such as the photomultiplier tube and the image intensifier is not limited to circular and square forms but rather may be of other forms such as rectangular and hexagonal forms. In addition, it is preferable for the material for forming the vacuum closed container to be glass that allows for easy joining to an MCP while it may be an insulator such as ceramics.

It is clear from the above description of the present invention that the present invention can be modified in a variety of manners. Such modifications should not be recognized as deviating from the spirit and the scope of the present invention and improvements which are obvious to every person skilled in the art are included in the following claims.

### INDUSTRIAL APPLICABILITY

As described above, an electron tube according to the present invention allows the maximum area of the multiplying portion of the electron multiplier from among the electron tubes having the same outer dimensions.

In addition, in the case of an electron tube such as a photomultiplier tube or an image intensifier where the photoelectric surface is placed so as to be opposed to the multiplying portion, the effective area of the photoelectric surface is also expanded as the multiplying portion is enlarged.

Accordingly, miniaturization of an electron tube or miniaturization of a device that uses an electron tube can be achieved. In particular, the dead space of the photoelectric surface that does not function is dramatically scaled down so that the efficiency of the conversion of the received light into electrons is greatly improved in a device wherein electron tubes are aligned in a matrix form.

1. An electron tube, comprising:
an electron multiplier which has a multiplying portion including a large number of microscopic holes for electron passage that allow for emission of secondary electrons and a peripheral portion that surrounds said multiplying portion; and
a vacuum closed container enclosing at least said multiplying portion of said electron multiplier, wherein
said peripheral portion of said electron multiplier forms at least a portion of the sidewalls of said vacuum closed container.

2. The electron tube according to claim 1 is a photomultiplier tube wherein a photoelectric surface is formed inside of said vacuum closed container so as to be opposed to one surface of said multiplying portion of said electron multiplier and wherein an anode is formed inside of said vacuum closed container so as to be opposed to the other surface of said multiplying portion of said electron multiplier.

3. The electron tube according to claim 1 is an image intensifier wherein a photoelectric surface is formed inside of said vacuum closed container so as to be opposed to one surface of said multiplying portion of said electron multiplier and wherein a fluorescent screen is formed inside of said vacuum closed container so as to be opposed to the other surface of said multiplying portion of said electron multiplier.

4. The electron tube according to claim 1, wherein said vacuum closed container has a pair of plates placed parallel to each other and sandwiching said electron multiplier, and
said peripheral portion of said electron multiplier is joined to a peripheral portion of each of said plates.

5. The electron tube according to claim 4, wherein said peripheral portion of at least one of said pair of plates includes a protrusion so that said peripheral portion of said electron multiplier is joined to said protrusion.

6. The electron tube according to claim 1, wherein said electron multiplier includes a micro-channel plate.

7. The electron tube according to claim 1, wherein an outer peripheral surface of said peripheral portion of said electron multiplier is exposed to the outer side.

8. The electron tube according to claim 1, wherein said multiplying portion and said peripheral portion of said electron multiplier are integrated.

9. The electron tube according to claim 1, wherein the thickness of said peripheral portion of said electron multiplier is greater than the thickness of said multiplying portion.

10. The electron tube according to claim 1, wherein the thickness of said peripheral portion of said electron multiplier is substantially the same as the thickness of said multiplying portion.

11. A manufacturing method for an electron tube, wherein:
a pair of plates as well as an electron multiplier which has a multiplying portion including a large number of microscopic holes for electron passage that allow for emission of secondary electrons and a peripheral portion that surrounds the multiplying portion are prepared; and
said electron multiplier is sandwiched between said pair of plates and at the same time said peripheral portion of the electron multiplier is joined to a peripheral portion of each of the pair of plates.
